(19) United States
(12) Patent Application Publication
(10) Pub. No.: US 2011/0300480 A1
(43) Pub. Date: Dec. 8, 2011

(54) Toner Compositions

(75) Inventors: Ke Zhou, Oakville (CA); Karen Ann Moffat, Brantford (CA); Richard P.N. Veregin, Mississauga (CA); Cuong Vong, Hamilton (CA)

(73) Assignee: XEROX CORPORATION, Norwalk, CT (US)

(21) Appl. No.: 13/214,195

(22) Filed: Aug. 21, 2011

Related U.S. Application Data
(62) Division of application No. 12/634,059, filed on Dec. 9, 2009, now abandoned.

(51) Int. Cl. G03G 9/093

(52) U.S. Cl. 430/108.11; 430/108.1; 430/108.4; 430/108.5; 430/137.11

(57) ABSTRACT

The present disclosure relates to a toner including a core comprising at least one amorphous resin, at least one crystalline resin and one or more optional ingredients such as optional colorants, optional waxes, gels, and combinations thereof. The toner also includes a shell having an environmentally friendly charge control agent co-emulsified with at least one amorphous shell resin.

### BACKGROUND

The present disclosure relates to toners suitable for electrophotographic apparatuses.

Numerous processes are within the purview of those skilled in the art for the preparation of toners. Emulsion aggregation (EA) is one such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Polyester EA ultra low melt (ULM) toners have been prepared utilizing amorphous and crystalline polyester resins. An issue which may arise with this formulation is that the crystalline polyester may migrate to the surface of the toner particle which, in turn, may adversely affect charging characteristics. Various processes/modifications have been suggested to avoid these issues. For example, the application of shells to the toner particles may be one way ₜo minimize the migration of a crystalline polyester to the toner particle surface. In other cases, charge control agents (CCAs) may be utilized to increase the charge on toner particles. However, most CCAs are formed of heavy metals, which are neither physiologically nor environmentally friendly. It thus remains desirable to improve the charging characteristics of EA toners possessing crystalline polyesters.

### SUMMARY

The present disclosure provides toners and processes for producing same. In embodiments, a toner of the present disclosure may include an emulsion aggregation toner including a core including at least one amorphous resin, at least one crystalline resin, and one or more optional ingredients such as colorants, waxes, styrene/acrylate gels, and combinations thereof; and a shell including at least one amorphous shell resin co-emulsified with one or more polymeric charge control agents.

In other embodiments a toner of the present disclosure may include an emulsion aggregation toner including a core including at least one amorphous resin, at least one crystalline resin and one or more optional ingredients such as colorants, waxes, styrene/acrylate gels, and combinations thereof; and a shell including at least one amorphous resin co-emulsified with a charge control agent such as

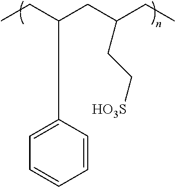

wherein n is from about 1 to about 1000,

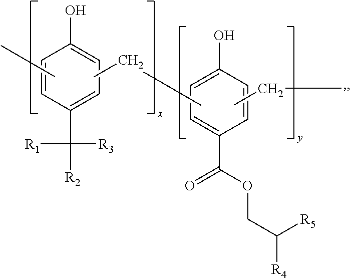

wherein x is 0.4 to 0.8, y is 0.2 to 0.6, R₁,R₂, and R₃ are each independently or an alkyl, and R₄ and R₅ are each independently an alkyl, and

a magnesium-aluminum hydroxide carbonate such as

Mg₄Al₂(OH)₁₂(CO₃)_{b}Zₐ.nH₂O, and

Mg₆Al₂(OH)₁₆(CO₃)_{b}Zₐ.nH₂O

where b is from 0 to 1, n is from zero to 10, Z is a combination of anions of sebacic acid with one or more C12-C44 fatty acids or a partly fluorinated or perflourinated sulfosuccinic acid (C6-C22)alkyl monoester, and the number a is such that Z accounts for from 1% to 45% by weight, based on the total weight of the compound, and where the ratio between sebacic acid and the fatty acid or the sulfosuccinic monoester is from 1:50 to 5:1, and combinations thereof.

In embodiments a process of the present disclosure may include contacting at least one amorphous resin with at least one crystalline resin and at least one styrene/acrylate gel in a mixture; aggregating the mixture to form core particles; contacting the core particles with an emulsion including an amorphous resin in combination with a charge control agent including at least one polymeric charge control agent to form a shell over the particles; and recovering the toner particles.

### BRIEF DESCRIPTION OF THE DRAWINGS

Various embodiments of the present disclosure will be described herein below with reference to the figures wherein:

FIG. 1 is a graph comparing the charging (in both A-zone and C-zone) of toners of the present disclosure, possessing charge control agents in the shell, with a control toner;

FIG. 2 is a graph comparing the charging (in both A-zone and C-zone) of toners of the present disclosure, possessing charge control agents in the shell, with a control toner;

FIG. 3 is a graph comparing the charging (in both A-zone and C-zone) of toners of the present disclosure, possessing charge control agents in the shell, with a control toner;

FIG. 4 is a graph comparing the charging (in both A-zone and C-zone) of toners of the present disclosure, possessing charge control agents in the shell, with a control toner; and

FIG. 5 is a graph comparing the charging (in both A-zone and C-zone) of toners of the present disclosure, possessing charge control agents in the shell, with a control toner.

### DETAILED DESCRIPTION

The present disclosure provides toner particles that are environmentally friendly and possess desirable charging properties. The toner particles possess a core-shell configuration, with an environmentally friendly charge control agent (CCA) included in the shell.

In embodiments, a CCA may be included in the shell by co-emulsifying a CCA and amorphous shell resin to form a CCA/amorphous resin emulsion. In some embodiments, the CCA may be emulsified with the amorphous shell resin using a solvent flash or phase inversion method, followed by evaporating the solvent. Because most CCAs are organic compounds stabilized with counter ions, they may stay in the latex micelles which contain the amorphous resin. Thus, an amorphous shell emulsion containing CCAs can be prepared for emulsion aggregation use.

### Core Resins

Any latex resin may be utilized in forming a toner core of the present disclosure. Such resins, in turn, may be made of any suitable monomer. Any monomer employed may be selected depending upon the particular polymer to be utilized.

In embodiments, the core resins may be an amorphous resin, a crystalline resin, and/or a combination thereof. In further embodiments, the polymer utilized to form the resin core may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, in embodiments from about 42 to about 55 mole percent, in embodiments from about 45 to about 53 mole percent, and the alkali sulfo-aliphatic diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent, and the alkali sulfo-aliphatic diacid can be selected in an amount of from about 1 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfa-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfa-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfo-isophthalate), copoly(propylene-butylene-terephthalate)-copoly(propylene-butylene-5-sulfo -isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(l,2-propylene itaconate), and combinations thereof.

In embodiments, a suitable polyester resin may be an amorphous polyester such as a poly(propoxylated bisphenol A co-fumarate) resin having the following formula (I):

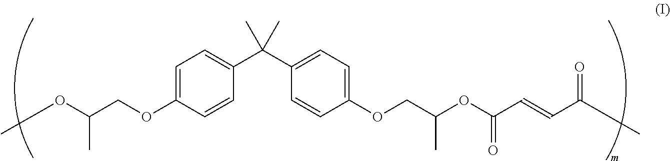

wherein m may be from about 5 to about 1000. Examples of such resins and processes for their production include those disclosed in U.S. Pat. No. 6,063,827, the disclosure of which is hereby incorporated by reference in its entirety.

An example of a propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

Suitable crystalline resins which may be utilized, optionally in combination with an amorphous resin as described above, include those disclosed in U.S. Patent Application Publication No. 2006/0222991, the disclosure of which is hereby incorporated by reference in its entirety. In embodiments, a suitable crystalline resin may include a resin formed of ethylene glycol and a mixture of dodecanedioic acid and fumaric acid co-monomers with the following formula:

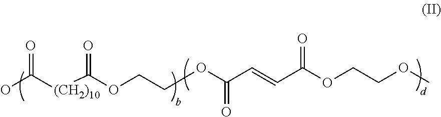

wherein b is from about 5 to about 2000 and d is from about 5 to about 2000.

For example, in embodiments, a poly(propoxylated bisphenol A co-fumarate) resin of formula I as described above may be combined with a crystalline resin of formula II to form a core.

In embodiments, the core resin may be a crosslinkable resin. A crosslinkable resin is a resin including a crosslinkable group or groups such as a C═C bond. The resin can be crosslinked, for example, through a free radical polymerization with an initiator. Thus, in embodiments, a resin utilized for forming the core may be partially crosslinked, which may be referred to, in embodiments, as a “partially crosslinked polyester resin” or a “polyester gel”. In embodiments, from about 1% by weight to about 50% by weight of the polyester gel may be crosslinked, in embodiments from about 5% by weight to about 35% by weight of the polyester gel may be crosslinked.

In embodiments, the amorphous resins described above may be partially crosslinked to form a core. For example, an amorphous resin which may be crosslinked and used in forming a toner particle in accordance with the present disclosure may include a crosslinked amorphous polyester of formula I above. Methods for forming the polyester gel include those within the purview of those skilled in the art. For example, crosslinking may be achieved by combining an amorphous resin with a crosslinker, sometimes referred to herein, in embodiments, as an initiator. Examples of suitable crosslinkers include, but are not limited to, for example, free radical or thermal initiators such as organic peroxides and azo compounds. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di(benzoyl peroxy)hexane, oo-t-butyl o-(2-ethyl hexyl)mono peroxy carbonate, and oo-t-amyl o-(2-ethyl hexyl)mono peroxy carbonate, alkyl peroxides such as, for example, dicumyl peroxide, 2,5-dimethyl 2,5-di(t-butyl peroxy)hexane, t-butyl cumyl peroxide, α-α-bis(t-butyl peroxy)diisopropyl benzene, di-t-butyl peroxide and 2,5-dimethyl 2,5di(t-butyl peroxy)hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2di(t-butyl peroxy)butane, ethyl 3,3-di(t-butyl peroxy)butyrate and ethyl 3,3-di(t-amyl peroxy)butyrate, and combinations thereof. Examples of suitable azo compounds include 2,2,’-azobis(2,4-dimethylpentane nitrile), azobis-isobutyronitrile, 2,2′-azobis (isobutyronitrile), 2,2′-azobis (2,4-dimethyl valeronitrile), 2,2′-azobis (methyl butyronitrile), 1,1′-azobis (cyano cyclohexane), other similar known compounds, and combinations thereof.

Although any suitable initiator can be used, in embodiments the initiator may be an organic initiator that is soluble in any solvent present, but not soluble in water. For example, half-life/temperature characteristic plots for VAZO® 52 (2,2,′-azobis(2,4-dimethylpentane nitrile), commercially available from E. I. du Pont de Nemours and Company, USA) shows a half-life greater than about 90 minutes at about 65° C. and less than about 20 minutes at about 80° C.

Where utilized, the initiator may be present in an amount of from about 0.5% by weight to about 20% by weight of the resin, in embodiments from about 1% by weight to about 10% by weight of the resin.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 40° C. to about 95° C., for a period of time of from about 1 minute to about 10 hours, in embodiments from about 5 minutes to about 5 hours, to form a crosslinked polyester resin or polyester gel suitable for use in forming toner particles.

In other embodiments, the core resin may include a crosslinked resin or gel formed from styrene and an acrylate, in embodiments an acrylate such as n-butyl acrylate, sometimes referred to herein, in embodiments, as a styrene/acrylate gel. Methods for forming such gels are within the purview of those skilled in the art. Examples of such polymers/gels include, for example, those disclosed in U.S. Pat. No. 7,291,437, the disclosure of which is hereby incorporated by reference herein it its entirety.

In embodiments, the resins utilized in the core may have a glass transition temperature of from about 30° C. to about 80° C., in embodiments from about 35° C. to about 70° C. In further embodiments, the resins utilized in the core may have a melt viscosity of from about 10 to about 1,000,000 Pa*S at about 130° C., in embodiments from about 20 to about 100,000 Pa*S.

One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin).

In embodiments, the resin may be formed by emulsion polymerization methods.

### Toner

The resin described above may be utilized to form toner compositions. Such toner compositions may include optional colorants, waxes, and other additives. Toners may be formed utilizing any method within the purview of those skilled in the art.

### Surfactants

In embodiments, colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toner composition, in embodiments from about 1% to about 3% by weight of the toner composition.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN RK™, and/or NEOGEN SC™ obtained from Daiichi Kogyo Seiyaku, combinations thereof, and the like. Other suitable anionic surfactants include, in embodiments, DOWFAX™2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido)phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion-aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 4 to about 5. Additionally, in embodiments, the mixture may be homogenized. If the mixture is homogenized, homogenization may be accomplished by mixing at about 600 to about 4,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes. The addition of the agent may also be done while the mixture is maintained under stirred conditions, in embodiments from about 50 revolutions per minute (rpm) to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a shell may be applied to the aggregated particles. In accordance with the present disclosure, a charge control agent (CCA) may be incorporated into the toner shell by adding the CCA to an emulsion including the resin utilized to form the shell. Addition of the CCA to the emulsion resin provides uniform distribution of the CCA throughout the shell, and thus more uniform toner charging.

Resins which may be utilized to form the shell include, but are not limited to, the amorphous resins described above for use in the core. In embodiments, an amorphous resin which may be used to form a shell in accordance with the present disclosure may include an amorphous polyester of formula I above.

In some embodiments, the amorphous resin utilized to form the shell may be crosslinked. For example, crosslinking may be achieved by combining an amorphous resin with a crosslinker, sometimes referred to herein, in embodiments, as an initiator. Examples of suitable crosslinkers include, but are not limited to, for example free radical or thermal initiators such as organic peroxides and azo compounds described above as suitable for forming a gel in the core. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di(benzoyl peroxy)hexane, oo-t-butyl o-(2-ethyl hexyl)mono peroxy carbonate, and oo-t-amyl o-(2-ethyl hexyl)mono peroxy carbonate, alkyl peroxides such as, for example, dicumyl peroxide, 2,5-dimethyl 2,5-di(t-butyl peroxy)hexane, t-butyl cumyl peroxide, α-α-bis(t-butyl peroxy)diisopropyl benzene, di-t-butyl peroxide and 2,5-dimethyl 2,5di(t-butyl peroxy)hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy)butane, ethyl 3,3-di(t-butyl peroxy)butyrate and ethyl 3,3-di(t-amyl peroxy)butyrate, and combinations thereof. Examples of suitable azo compounds include 2,2,'-azobis(2,4-dimethylpentane nitrile), azobis-isobutyronitrile, 2,2′-azobis(isobutyronitrile), 2,2′-azobis (2,4-dimethyl valeronitrile), 2,2′-azobis(methyl butyronitrile), 1,1′-azobis(cyano cyclohexane), other similar known compounds, and combinations thereof.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 30° C. to about 95° C., for a period of time of from about 1 minute to about 10 hours, in embodiments from about 5 minutes to about 5 hours, to form a crosslinked polyester resin or polyester gel suitable for use as a shell.

Where utilized, the crosslinker may be present in an amount of from about 0.001% by weight to about 5% by weight of the resin, in embodiments from about 0.01% by weight to about 1% by weight of the resin. The amount of CCA may be reduced in the presence of crosslinker or initiator.

A single polyester resin may be utilized as the shell or, in embodiments, a first polyester resin may be combined with other resins to form a shell. Multiple resins may be utilized in any suitable amounts. In embodiments, a first amorphous polyester resin, for example an amorphous resin of formula I above, may be present in an amount of from about 20 percent by weight to about 100 percent by weight of the total shell resin, in embodiments from about 30 percent by weight to about 90 percent by weight of the total shell resin. Thus, in embodiments, a second resin may be present in the shell resin in an amount of from about 0 percent by weight to about 80 percent by weight of the total shell resin, in embodiments from about 10 percent by weight to about 70 percent by weight of the shell resin.

### Charge Control Agents

In embodiments, it may be desirable to incorporate a CCA into the toner formulation, in embodiments by co-emulsifying a charge control agent with a resin utilized to form a shell.

Conventional CCAs, including those sold as VALIFAST® BLACK 3804, BONTRON® S-31, BONTRON® S-32, BONTRON® S-34, BONTRON® S-36, BONTRON® E-88, (commercially available from Orient Chemical Industries, Ltd.), T-77, and AIZEN SPILON BLACK TRH (commercially available from Hodogaya Chemical Co., Ltd.), may include heavy metals such as Zr, Co, and/or Ni, which are both environmentally and physiologically undesirable. In accordance with the present disclosure, the CCAs included in the toner are environmentally friendly. The term “environmentally friendly” as used herein refers to agents free of heavy metals. In embodiments, the CCAs of the present disclosure may be organic or inorganic polymers.

In embodiments, an environmentally friendly CCA includes an organic polymer. Exemplary organic polymers include, for example, FCA3001N, commercially available from Fujikura Kasei Co., Ltd., set forth as Formula III below:

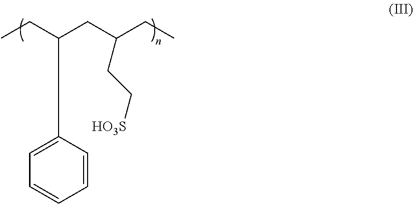

where n is from about 1 to about 1000.

Another environmentally friendly organic polymeric CCA may be, for example, FCA2521N commercially available from Fujikura Kasei Co., Ltd., set forth as Formula IV below:

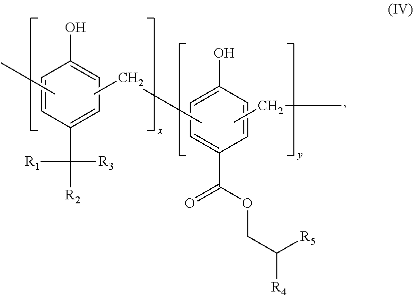

where x is from about 0.4 to about 0.8, y is from about 0.2 to about 0.6, R₁,R₂, and R₃ are each independently hydrogen or an alkyl; and R₄ and R₅ are each independently an alkyl. Other environmentally friendly CCAs include functionalized inorganic polymer salts. The polymer salts may be an inorganic silicate polymer layer, or salts of layered double hydroxides, combinations thereof, and the like.

In embodiments, a charge control agent may include a combination of the CCAs of formulas III and IV above, at a weight ratio of from about 10:90 to about 90:10, in embodiments from about 25:75 to about 75:25.

Examples of inorganic polymer salts which may be used as a polymeric charge control agent include magnesium-aluminum hydroxide carbonate inorganic polymers, having an Mg to Al molar ratio of from about 4:1 to about 1:4, in embodiments from about 3.1:1 to about 1.9:1, containing anions in the following proportion based on the total weight of the Mg—Al hydroxide carbonate: from 1% to 45% by weight of a combination of sebacic acid with a C12-C44 fatty acid or a partly fluorinated or perflourinated sulfosuccinic acid (C6-C22)alkyl monoester, the ratio between sebacic acid and the fatty acid or the sulfosuccinic monoester being from 1:50 to 5:1.

An example of such negatively charged inorganic polymeric charge control agents include those set forth as Formulas V and VI below:

Mg₄Al₂(OH)₁₂(CO₃)_{b}Zₐ.nH₂O (V)

or

Mg₆Al₂(OH)₁₆(CO₃)_{b}Zₐ.nH₂O (VI)

where b is from 0 to 1, n is from zero to 10, Z is a combination of anions of sebacic acid with one or more C₁₂-C₄₄ fatty acids or partly fluorinated or perflourinated sulfosuccinic acid (C6-C22)alkyl monoesters, and the number a is such that Z accounts for from about 1% to about 45% by weight, based on the total weight of the compound, and where the ratio between sebacic acid and the fatty acid or the sulfosuccinic monoester is from about 1:50 to about 5:1. Such charge control agents include those sold as COPY CHARGE™ N5P-01, commercially available from Clariant International Ltd.

An emulsion including the resin and CCA may be prepared using any method within the purview of those skilled in the art. In embodiments, the CCA and resin may be combined utilizing a solvent flash method, a solventless emulsification method, or a phase inversion method. Examples of the solvent flash methods include those disclosed in U.S. Pat. No. 7,029,817, the disclosure of which is hereby incorporated by reference in its entirety. Examples of solventless emulsification methods include those disclosed in U.S. patent application Ser. No. 12/032,173 filed Feb. 15, 2008, the disclosure of which is hereby incorporated by reference in its entirety. Examples of the suitable phase inversion method include those disclosed in U.S. Patent Application Publication No. 2007/0141494, the disclosure of which is hereby incorporated by reference in its entirety. In further embodiments, the CCA and resin may be combined using a solvent emulsification method, wherein the CCA and resin are dissolved in an organic solvent, followed by introducing the above solution in deionized water under homogenization.

In embodiments, the CCA may be added to an emulsion utilized to form a shell on a toner particle. The CCA may be added in any amount, for example, the CCA may be added in an amount from about 0.1% to about 10% by weight of the emulsion. The percentage of CCA based on total dry toner weight may be from about 0.1% to about 5%, in embodiments from about 0.5% to about 3%.

The toner shell emulsion may be prepared, for example, by combining an amorphous resin with the CCA and an organic solvent such as, for example, ethyl acetate. This mixture may be stirred to dissolve the resin and CCA. In a separate glass reactor flask, a suitable salt such as sodium bicarbonate, and a suitable non-ionic surfactant such as DOWFAX™ 2A1, an alkyldiphenyloxide disulfonate from The Dow Chemical Company, and water may be homogenized by mixing at a speed of from about 1000 rpm to about 15000 rpm, in embodiments from about 3000 rpm to about 10000 rpm, with slow addition of the resin/CCA mixture. Upon complete homogenization, the mixture may undergo distillation to remove the organic solvent. Finally, the emulsion may be sieved through a 25 μm sieve.

The shell resin and CCA may be applied to the aggregated particles by any method within the purview of those skilled in the art. In embodiments, the polyester resin utilized to form the shell in combination with the CCA may be in a surfactant described above as an emulsion. The emulsion possessing the polyester resin and CCA may be combined with the aggregated particles described above so that the shell forms over the aggregated particles. Where the resin and CCA are in an emulsion, the emulsion may possess from about 1 percent solids by weight of the emulsion to about 80 percent solids by weight of the emulsion, in embodiments from about 5 percent solids by weight of the emulsion to about 60 percent solids by weight of the emulsion.

In embodiments, the resulting emulsion utilized to form the shell may include a charge control agent in an amount of from about 0.1 percent by weight of the emulsion to about 20 percent by weight of the emulsion, in embodiments from about 0.5 percent by weight of the emulsion to about 10 percent by weight of the emulsion, and the at least one polyester resin latex in an amount of from about 80 percent by weight of the emulsion to about 99.9 percent by weight of the emulsion, in embodiments from about 90 percent by weight of the emulsion to about 99.5 percent by weight of the emulsion.

The resulting shell may thus include the charge control agent in an amount of from about 0.1 percent by weight of the shell to about 20 percent by weight of the shell, in embodiments from about 0.5 percent by weight of the shell to about 5 percent by weight of the shell, and the at least one polyester resin latex in an amount of from about 80 percent by weight of the shell to about 99.9 percent by weight of the shell, in embodiments from about 90 percent by weight of the shell to about 99.5 percent by weight of the shell.

The formation of the shell over the aggregated particles may occur while heating to an elevated temperature in embodiments from about 35° C. to about 99° C., in embodiments from about 40° C. to about 80° C. The formation of the shell may take place for a period of time of from about 1 minute to about 5 hours, in embodiments from about 5 minutes to about 3 hours.

Utilizing the resin/CCA combination to form a shell provides the resulting toner particles with desirable charging characteristics and desirable sensitivity to relative humidity, while preventing the crystalline polyester from migrating to the surface of the toner particles.

Through the processes of the present disclosure, most CCAs can be incorporated in an EA Ultra Low Melt toner. Furthermore, compared to conventional processes which melt mix CCAs with toner resins and other components, the amount of CCAs needed in accordance with the present disclosure may be reduced since they only need to be added to the toner shell. Moreover, charging, relative humidity (RH) sensitivity, and parent toner flow performance may be improved compared with conventional toners.

In embodiments, the toner core may have a size from about 2 microns to about 8.5 microns, in embodiments from about 2.5 microns to about 7.5 microns, and in embodiments from about 3 microns to about 5.5 microns. The toner shell may have a thickness from about 100 nm to about 3 microns, in embodiments from about 500 nm to about 2 microns. The volume percentage of the shell may be, for example, from about 15 percent to about 50 percent of the toner, in embodiments from about 20 percent to about 40 percent of the toner, in embodiments from about 25 percent to about 30 percent of the toner.

In embodiments, the toner may include a core/shell structure, with the shell including a CCA. In other embodiments, the toner may include a core/shell structure, with the shell including a CCA, but no CCA in the core.

Incorporation of a CCA in only the shell portion of the toner can therefore reduce the amount of CCA required while achieving the same or even better charging results. Compared to conventional approaches where the CCA is homogeneously distributed in the toner, the approach of the present disclosure can reduce the amount of CCA by, for example, from about 50 percent to about 85 percent, in embodiments from about 60 percent to about 80 percent, and in embodiments from about 70 percent to about 75 percent.

### Coalescence

Following aggregation to the desired particle size and application of the shell resin described above, the particles may then be coalesced to the desired final shape, the coalescence being achieved by, for example, heating the mixture to a suitable temperature. This temperature may, in embodiments, be from about 0° C. to about 50° C. higher than the onset melting point of the crystalline polyester resin utilized in the core, in other embodiments from about 5° C. to about 30° C. higher than the onset melting point of the crystalline polyester resin utilized in the core. For example, by utilizing the polyester gel in forming a shell as described above, in embodiments the temperature for coalescence may be from about 40° C. to about 99° C., in embodiments from about 50° C. to about 95° C. Higher or lower temperatures may be used, it being understood that the temperature is a function of the resins used.

Coalescence may also be carried out with stirring, for example at a speed of from about 50 rpm to about 1,000 rpm, in embodiments from about 100 rpm to about 600 rpm. Coalescence may be accomplished over a period of from about 1 minute to about 24 hours, in embodiments from about 5 minutes to about 10 hours.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

The shell resin may be able to prevent any crystalline resin in the core from migrating to the toner surface. In addition, the shell resin may be less compatible with the crystalline resin utilized in forming the core, which may result in a higher toner glass transition temperature (Tg). For example, toner particles having a shell of the present disclosure may have a glass transition temperature of from about 30° C. to about 80° C., in embodiments from about 35° C. to about 70° C. This higher Tg may, in embodiments, improve blocking and charging characteristics of the toner particles, including A-zone charging.

The presence of the CCA in the shell may also improve blocking and charging characteristics of the toner particles, including A-zone charging, as well as relative humidity sensitivity and cohesiveness.

In embodiments, the polyester resin utilized to form the shell may be present in an amount of from about 2 percent by weight to about 40 percent by weight of the dry toner particles, in embodiments from about 5 percent by weight to about 35 percent by weight of the dry toner particles.

### Additives

In embodiments, the toner particles may also contain other optional additives, as desired or required. For example, there can be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal and amorphous silicas, such as AEROSIL®, metal salts and metal salts of fatty acids inclusive of zinc stearate, aluminum oxides, cerium oxides, and mixtures thereof. Each of these external additives may be present in an amount of from about 0.1 percent by weight to about 5 percent by weight of the toner, in embodiments of from about 0.25 percent by weight to about 3 percent by weight of the toner. Suitable additives include those disclosed in U.S. Pat. Nos. 3,590,000, 3,800,588, 6,214,507, and 7,452,646 the disclosures of each of which are hereby incorporated by reference in their entirety. Again, these additives may be applied simultaneously with the shell resin described above or after application of the shell resin.

In embodiments, toners of the present disclosure may be utilized as ultra low melt (ULM) toners. In embodiments, the dry toner particles having a shell of the present disclosure may, exclusive of external surface additives, have the following characteristics:

(1) Volume average diameter (also referred to as “volume average particle diameter”) of from about 3 to about 25 μm, in embodiments from about 4 to about 15 μm, in other embodiments from about 5 to about 12 μm.

(2) Number Average Geometric Size Distribution (GSDn) and/or Volume Average Geometric Size Distribution (GSDv) of from about 1.05 to about 1.55, in embodiments from about 1.1 to about 1.4.

(3) Circularity of from about 0.93 to about 1, in embodiments from about 0.95 to about 0.99 (measured with, for example, a Sysmex FPIA 2100 analyzer).

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Toners of the present disclosure may possess A zone charging of from about −3 μC/g to about −60 μC/g, in embodiments from about −4 μC/g to about −50 μC/g, a parent toner charge per mass ratio (Q/M) of from about −3 μC/g to about −60 μC/g, in embodiments from about −4 μC/g to about −50 μC/g, and a final triboelectric charge of from −4 μC/g to about −50 μC/g, in embodiments from about −5 μC/g to about −40 μC/g.

In accordance with the present disclosure, the charging of the toner particles may be enhanced, so less surface additives may be required, and the final toner charging may thus be higher to meet machine charging requirements.

### Developers

The toner particles thus obtained may be formulated into a developer composition. The toner particles may be mixed with carrier particles to achieve a two-component developer composition. The toner concentration in the developer may be from about 1% to about 25% by weight of the total weight of the developer, in embodiments from about 2% ₜo about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrophotographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with an electrophotographic device including a charging component, an imaging component, a photoconductive component, a developing component, a transfer component, and a fusing component. In embodiments, the development component may include a developer prepared by mixing a carrier with a toner composition described herein. The electrophotographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

In embodiments where the toner resin is crosslinkable, such crosslinking may be accomplished in any suitable manner. For example, the toner resin may be crosslinked during fusing of the toner to the substrate where the toner resin is crosslinkable at the fusing temperature. Crosslinking also may be affected by heating the fused image to a temperature at which the toner resin will be crosslinked, for example in a post-fusing operation. In embodiments, crosslinking may be effected at temperatures of from about 160° C. or less, in embodiments from about 70° C. to about 160° C., in other embodiments from about 80° C. to about 140° C.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Comparative Example 1

Preparation of a toner that does not contain a charge control agent. A toner was formed as described hereinbelow.

### Preparation of Gel Latex A

A latex emulsion including polymer gel particles generated from the semi-continuous emulsion polymerization of styrene, n-butyl acrylate, divinylbenzene, and beta-carboxyethyl acrylate (β-CEA) was prepared as follows.

A surfactant solution including about 1.75 kilograms NEOGEN RK (an anionic emulsifier from Daiichi Kogyo Seiyaku Co. Ltd., Japan), which is primarily a branched sodium dodecyl benzene sulfonate, and about 145.8 kilograms of deionized water was prepared by mixing for about 10 minutes in a stainless steel holding tank. The holding tank was then purged with nitrogen for about 5 minutes before transferring into the reactor. The reactor was then continuously purged with nitrogen while being stirred at about 300 revolutions per minute (rpm). The reactor was then heated up to about 76° C. at a controlled rate and held constant. In a separate container, about 1.24 kilograms of ammonium persulfate initiator was dissolved in about 13.12 kilograms of de-ionized water.

In a second separate container, a monomer emulsion was prepared in the following manner. About 47.39 kilograms of styrene, about 25.52 kilograms of n-butyl acrylate, about 2.19 kilograms of β-CEA, about 729 grams of 55% grade divinylbenzene, about 4.08 kilograms of NEOGEN RK (anionic surfactant), and about 78.73 kilograms of deionized water were mixed to form an emulsion. The ratio of styrene monomer to n-butyl acrylate monomer by weight was about 65 to 35 percent.

One percent of the above emulsion was then slowly fed into the reactor containing the aqueous surfactant phase at about 76° C. to form seed particles while being purged with nitrogen. The initiator solution was then slowly charged into the reactor and after about 20 minutes the rest of the emulsion was continuously fed in using metering pumps.

Once all the monomer emulsion was charged into the main reactor, the temperature was held at about 76° C. for an additional 2 hours to complete the reaction. Full cooling was then applied and the reactor temperature was reduced to about 35° C. The product was collected into a holding tank after filtration through a 1 micron filter bag. After drying a portion of the latex the molecular properties were measured to be weight average molecular weight (Mw)=134,700, number average molecular weight (Mn)=27,300 and the onset glass transition temperature (Tg) was 43° C. The average particle size of the latex as measured by Disc Centrifuge was about 48 nanometers and residual monomer as measured by gel chromatography (GC) was <50 ppm for styrene and <100 ppm for n-butyl acrylate.

### Preparation of Toner

About 138.76 grams of an amorphous resin of the following formula

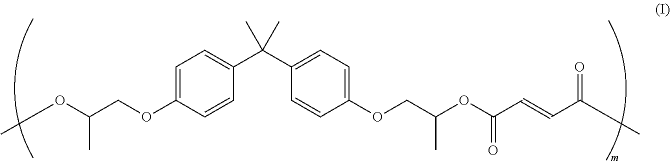

wherein m may be from about 5 to about 1000, in an emulsion (about 43.45% by weight), was combined with about 48.39 grams of an unsaturated crystalline polyester resin (“UCPE”) of the following formula

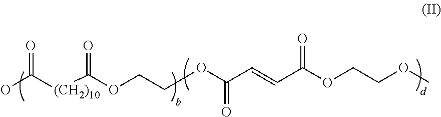

wherein b is from about 5 to about 2000 and d is from about 5 to about 2000, in an emulsion (about 29.76% by weight), and about 16.40 grams of gel latex A (about 43.60% by weight), about 28.53 grams cyan Pigment Blue 15:3 (about 17.42% by weight), and about 549.71 grams de-ionized water, in a 2 liter beaker. To this mixture, about 35.84 grams of aluminum sulfate (about 1.0 weight %) was added as a flocculent under homogenization by mixing at a speed of about 3500 rpm.

The mixture was transferred to a two liter Buchi reactor, and heated to about 44.5° C. at a speed of about 700 revolutions per minute (rpm) to induce aggregation. The particle size was monitored with a Coulter counter until the core particles reached a volume average particle size of about 6.82 μm with a geometric size distribution (“GSD”) of about 1.22. When the desired particle size and GSD were achieved, an additional amount of about 77.72 grams of the amorphous resin was added to the mixture as a shell. The resulting core particles with the shell had an average particle size of about 9.05 μm and a GSD of about 1.20.

The pH of the reaction slurry was adjusted with sodium hydroxide to a pH of about 7.5. The pH adjusted particles were frozen and then heated to induce coalescence. The resulting toner had a particle size of about 8.41 μm, a GSD of about 1.24, and a circularity of about 0.963.

The toner was cooled to room temperature, separated by sieving with a 25 μm sieve, filtered, washed, and freeze dried.

### Example 1

An emulsion including about 1% of a charge control agent in the toner shell was prepared as follows. In a two liter beaker containing about 900 grams ethyl acetate, about 125 grams of the amorphous resin of formula I above in Comparative Example 1 was combined with about 1.25 grams of a charge control agent of Formula (III) having the structure below

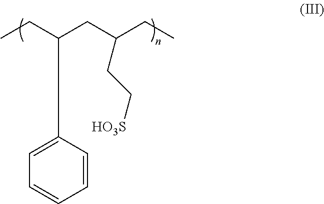

where n is from about 1 to about 1000.

The mixture was stirred at about 300 rpm at room temperature to dissolve the resin and the charge control agent. In a separate four liter glass flask reactor, about 700 grams de-ionized water, about 3.55 grams sodium bicarbonate, and about 2.74 grams of DOWFAX non-ionic surfactant (about 47 weight %) were homogenized with an IKA Ultra Turrax T50 homogenizer at about 4,000 rpm. The resin solution was then slowly poured into the water solution during homogenization. The speed of the homogenizer was increased to about 8,000 rpm for about 30 minutes.

Following completion of homogenization, the glass flask reactor was placed in a heating mantle and attached to a distillation device. The mixture was stirred at about 275 rpm and the temperature of the mixture was increased to about 80° C. at a rate of about 1° C. per minute to distill off the ethyl acetate from the mixture. The distillation was continued for about 120 minutes after which the mixture was cooled at a rate of about 2° C. per minute to room temperature. The mixture was then sieved through a 25 μm sieve.

### Example 2

Toner particles were prepared with the emulsion from Example 1 as the shell. The amount of the charge control agent in the toner particles was about 0.28% by weight based upon the dry toner weight.

About 137.68 grams of the amorphous resin of formula I above from Comparative Example 1, in an emulsion (about 43.79% by weight), was combined with about 48.39 grams of the unsaturated crystalline resin of Formula II above from Comparative Example 1 in an emulsion (about 29.76% by weight), about 16.40 grams of gel latex A (about 43.60% by weight), about 28.53 grams cyan pigment PB 15:3 (about 17.42% by weight), and about 548.22 grams de-ionized water, in a two liter beaker. About 35.84 grams aluminum sulfate (about 1% by weight) was added as a flocculent under homogenization. The mixture was transferred to a two liter Buchi reactor and heated to about 44° C. at a speed of about 700 rpm to induce aggregation. The particle size was monitored with a Coulter counter until the core particles reached a volume average particle size of about 6.82 μm with a GSD of about 1.22. When the desired particle size and GSD were achieved, about 78.95 grams of the emulsion from Example 1 (about 42.77% by weight), including the amorphous resin and the charge control agent was added to the mixture as a shell. The resulting core particles with the shell had an average particle size of about 8.24 μm and a GSD of about 1.21.

The pH of the shell/core particles was adjusted with sodium hydroxide to a pH of about 7.5. The pH adjusted particles were frozen and then heated to induce coalescence. The resulting toner had a particle size of about 8.15 μm a GSD of about 1.23.

The toner was cooled to room temperature, separated by sieving with a 25 μm sieve, filtered, washed, and freeze dried.

### Example 3

The process of Example 1 was followed, except 12.5 grams of a charge control agent of Formula (IV), having the structure below, were added as the CCA.

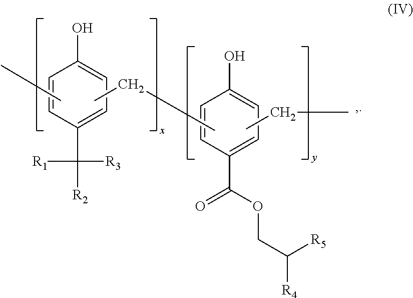

where x is 0.4 to 0.8, y is 0.2 to 0.6, R₁,R₂, and R₃ are each independently hydrogen or an alkyl; and R₄ and R₅ are each independently an alkyl.

### Example 4

Toner particles were then prepared with the emulsion from Example 3 as the shell. The amount of the charge control agent in the toner particles was about 0.28% by weight based upon the dry toner weight.

About 137.68 grams of the amorphous resin of formula I above from Comparative Example 1 in an emulsion (about 43.79% by weight), was combined with about 48.39 grams of the unsaturated crystalline polyester resin of formula II above from Comparative Example 1 in an emulsion (about 29.76% by weight), about 16.40 grams of gel latex A (about 43.6% by weight), about 28.53 grams cyan pigment PB 15:3 (about 17.42% by weight), and about 548.22 grams de-ionized water in a two liter beaker. About 35.84 grams aluminum sulfate (about 1% by weight) was added as a flocculent under homogenization. The mixture was transferred to a two liter Buchi reactor and heated to about 44° C. at a speed of about 700 rpm to induce aggregation. The particle size was monitored with a Coulter counter until the core particles reached a volume average particle size of about 7.11 μm with a GSD of about 1.21. When the desired particle size and GSD were achieved, about 141.76 grams of the emulsion from Example 3 (about 23.82% by weight), including the amorphous resin and the charge control agent was added to the mixture as a shell. The resulting core particles with the shell had an average particle size of about 7.90 μm and a GSD of about 1.21.

The pH of the shell/core particles was adjusted with sodium hydroxide to a pH of about 7.5. The pH adjusted particles were frozen and then heated to induce coalescence. The resulting toner had a particle size of about 8.15 μm a GSD of about 1.25.

The toner was cooled to room temperature, separated by sieving with a 25 μm sieve, filtered, washed, and freeze dried.

### Example 5

An emulsion including about 1% of a charge control agent in the toner shell was prepared as follows. The process of Example 1 was repeated, except about 1.25 grams of a charge control agent of Formula (V), having the structure below, was added as the CCA.

Mg₄Al₂(OH)₁₂(CO₃)_{b}Zₐ.nH₂O (V)

where b is from 0 to 1, n is from zero to 10, Z is a combination of anions of sebacic acid and anions of one or more C12-C44 fatty acids, and the number a is such that Z accounts for from 1% to 45% by weight, based on the total weight of the compound, and where the ratio between sebacic acid and the fatty acid is from 1:50 to 5:1.

### Example 6

Toner particles were then prepared with the emulsion from Example 5 as the shell. The amount of the charge control agent in the toner particles was about 0.28% by weight based upon the dry toner weight.

About 137.68 grams of the amorphous resin of formula I above from Comparative Example 1 in an emulsion (about 43.79% by weight), was combined with about 48.39 grams of the unsaturated crystalline polyester resin of formula II above from Comparative Example 1 in an emulsion (about 29.76% by weight), about 16.40 grams of gel latex A (about 43.60% by weight), about 28.53 grams cyan pigment PB 15:3 (about 17.42% by weight), and about 549.71 grams de-ionized water in a two liter beaker. About 35.84 grams aluminum sulfate (1.0% by weight) was added as a flocculent under homogenization. The mixture was transferred to a two liter Buchi reactor and heated to about 49.2° C. at a speed of about 700 rpm to induce aggregation. The particle size was monitored with a Coulter counter until the core particles reached a volume average particle size of about 6.68 μm with GSD of about 1.29. When the desired particle size and GSD were achieved, about 213.45 grams of the emulsion from Example 5 (about 15.82% by weight), including the amorphous resin and the charge control agent Formula (V) was added to the mixture as a shell. The resulting core particles with the shell had an average particle size of about 9.44 μm and a GSD of about 1.23.

The pH of the shell/core particles was adjusted with sodium hydroxide to a pH of about 7.5. The pH adjusted particles were frozen and then heated to induce coalescence. The resulting toner had a particle size of about 9.05 μm a GSD of about 1.26.

The toner was cooled to room temperature, separated by sieving with a 25 μm sieve, filtered, washed, and freeze dried.

### Example 7

An emulsion including about 1.5% of a charge control agent in the toner shell was prepared as follows. About 50 grams of the amorphous resin of formula I above from Comparative Example 1 in an emulsion, was combined with about 0.75 grams of a charge control agent of Formula (IV) in a two liter beaker containing about 900 grams ethyl acetate. The mixture was stirred at about 300 rpm at room temperature to dissolve the resin and the charge control agent. In a separate four liter glass flask reactor, about 700 grams de-ionized water, about 3.55 grams sodium bicarbonate, and about 2.74 grams of DOWFAX 2A1 non-ionic surfactant were homogenized with an IKA Ultra Turrax T50 homogenizer at about 4,000 rpm. The resin solution was then slowly poured into the water solution during homogenization. The speed of the homogenizer was increased to about 8,000 rpm for about 30 minutes.

Following completion of homogenization, the glass flask reactor was placed in a heating mantle and attached to a distillation device. The mixture was stirred at about 275 rpm and the temperature of the mixture was increased to 80° C. at a rate of about 1° C. per minute to distill off the ethyl acetate from the mixture. The distillation continued for about 120 minutes after which the mixture was cooled at a rate of about 2° C. per minute to room temperature. The mixture was then sieved through a 25 μm sieve.

### Example 8

Toner particles were then prepared with the emulsion from Example 7 as the shell. The amount of the charge control agent in the toner particles was about 0.42% by weight based upon the dry toner weight.

About 130.61 grams of the amorphous resin of formula I above from Comparative Example 1 in an emulsion (about 46.16% by weight), was combined with about 48 grams unsaturated crystalline resin of formula II above from Comparative Example 1 in an emulsion (about 30% by weight), about 17.18 grams of gel latex A (about 41.6% by weight), about 29.24 grams cyan pigment PB 15:3 (about 17% by weight), and about 556.78 grams de-ionized water in a two liter beaker. About 35.84 grams aluminum sulfate (about 1% by weight) was added as a flocculent under homogenization. The mixture was transferred to a two liter Buchi reactor and heated to about 44° C. at a speed of about 700 rpm to induce aggregation. The particle size was monitored with a Coulter counter until the core particles reached a volume average particle size of about 7 μm. When the desired particle size was achieved, about 174 grams of the emulsion from Example 7 (about 19.31% by weight), including the amorphous resin and the charge control agent of Formula (IV) was added to the mixture as a shell. The resulting core particles with the shell had an average particle size of about 9 μm.

The pH of the shell/core particles was adjusted with sodium hydroxide to a pH of about 7.5. The pH adjusted particles were frozen and then heated to induce coalescence. The resulting toner had a particle size of about 8.87 μm a GSD of about 1.25.

The toner was cooled to room temperature, separated by sieving with a 25 μm sieve, filtered, washed, and freeze dried.

### Example 9

An emulsion including about 1% of two different charge control agents in the toner shell was prepared as follows. About 100 grams of the amorphous resin of formula I above from Comparative Example 1, about 1 gram of a charge control agent of Formula (III), and about 1 gram of a charge control agent of Formula (IV) were added to a two liter beaker containing about 900 grams ethyl acetate.

The mixture was stirred at about 300 rpm at room temperature to dissolve the resin and the charge control agents. In a separate four liter glass flask reactor, about 700 grams de-ionized water, about 3.55 grams sodium bicarbonate, and about 2.74 grams of DOWFAX non-ionic surfactant were homogenized with an IKA Ultra Turrax T50 homogenizer at about 4,000 rpm. The resin solution was then slowly poured into the water solution during homogenization. The speed of the homogenizer was increased to about 8,000 rpm for about 30 minutes.

Following completion of homogenization, the glass flask reactor was placed in a heating mantle and attached to a distillation device. The mixture was stirred at about 275 rpm and the temperature of the mixture was increased to about 80° C. at a rate of about 1° C. per minute to distill off the ethyl acetate from the mixture. The distillation was continued for about 120 minutes after which the mixture was cooled at a rate of about 2° C. per minute to room temperature. The mixture was then sieved through a 25 μm sieve.

### Example 10

Toner particles were then prepared with the emulsion from Example 9 as the shell. The amount of the charge control agents in the toner particles was about 0.56% by weight based upon the dry toner weight.

About 130.61 grams of the amorphous resin of formula I above from Comparative Example 1 in an emulsion (about 46.16% by weight), was combined with about 48 grams of the unsaturated crystalline resin of formula II above from Comparative Example 1 in an emulsion (about 30% by weight), about 17.18 grams gel latex A (about 41.6% by weight), about 29.24 grams cyan pigment PB 15:3 (about 17% by weight), and about 556.78 grams de-ionized water in a two liter beaker. About 47.79 grams aluminum sulfate (about 1% by weight) was added as a flocculent under homogenization. The mixture was transferred to a two liter Buchi reactor and heated to about 44° C. at a speed of about 700 rpm to induce aggregation. The particle size was monitored with a Coulter counter until the core particles reached a volume average particle size of about 7 μm. When the desired particle size was achieved, about 147.63 grams of the emulsion from Example 9 (about 22.76% by weight), including the amorphous resin and the charge control agents (III) and (IV) was added to the mixture as a shell. The resulting core particles with the shell had an average particle size of about 8.5 μm.

The pH of the shell/core particles was adjusted with sodium hydroxide to a pH of about 7.5. The pH adjusted particles were frozen and then heated to induce coalescence. The resulting toner had a particle size of about 8.41 μm a GSD of about 1.23.

The toner was cooled to room temperature, separated by sieving with a 25 μm sieve, filtered, washed, and freeze dried.

Charging characteristics of the toners of the present disclosure as set forth in the above Examples and the toner of the Comparative Example were determined by a total blow-off apparatus, also known as a Barbetta box. Developers were conditioned overnight in A and C zones and then charged using a paint shaker for from about 5 minutes to about 60 minutes to provide information about developer stability with time and between zones. The low-humidity zone (C zone, or CZ) was about 10° C./15% relative humidity (RH), while the high humidity zone (A zone, or AZ) was about 28° C./85% RH. Toners of the present disclosure exhibited a parent toner charge per mass ratio (Q/M) of from about −1.82 to about −20.4 Q/M at 5 minutes (5M) in the A zone, from about −23.22 to about −56.4 Q/M at 5M in the C zone, from about −3.6 to about −56.4 Q/M at 60 minutes (60M) in the A zone, and from about −25.67 to about −66.8 Q/M at 60M in the C zone, as shown in Table 1 below:

TABLE 1

| | COMPARATIVE | | | | | |
|---|---|---|---|---|---|---|
| | EXAMPLE 1 | EXAMPLE 1 | EXAMPLE 2 | EXAMPLE 3 | EXAMPLE 4 | EXAMPLE 5 |
| Parent Toners | Control | 1% (CCA III) | 1% (CCA IV) | 1% (CCA V) | 1.5% (CCA IV) | 1% (CCA IV) + 1% |
| | | | | | | (CCA III) |
| Q/m 5M AZ | −6.064 | −1.82 | −5.17 | −4.3 | −9.0 | −20.4 |
| Q/m 5M CZ | −30.573 | −23.22 | −50.91 | −44.49 | −29.0 | −56.4 |
| Q/m 60M AZ | −8.187 | −3.6 | −13.13 | −4.64 | −9.0 | −24.4 |
| Q/m 60M CZ | −36.033 | −25.67 | −60.74 | −40.25 | −46.0 | −66.8 |
| C:A Ratio 5M | 5.04 | 12.74 | 9.85 | 10.34 | 3.2 | 2.8 |
| C:A Ratio 60M | 4.44 | 7.13 | 4.62 | 8.68 | 5.1 | 2.7 |
| Cohesion | 92.33% | 76.55% | 88.9% | 83.35% | 84.0% | 70.0% |

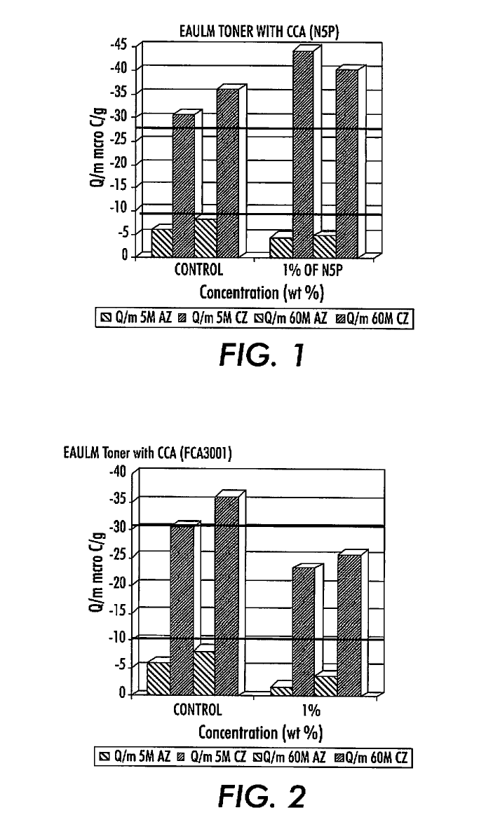

With reference now to the figures, as shown in FIG. 1, addition of the inorganic polymeric charge control agent of Formula (V) at a concentration of 1% in the shell of the toner of Example 6 significantly decreased the toner charge in the C zone as compared to the toner without any charge control agent (Comparative Example 1).

FIG. 2 shows that addition of 1% organic polymeric charge control agent of Formula (III) in the shell decreased both A-zone and C-zone charging. However, it improved heat cohesion as seen above in Table 1.

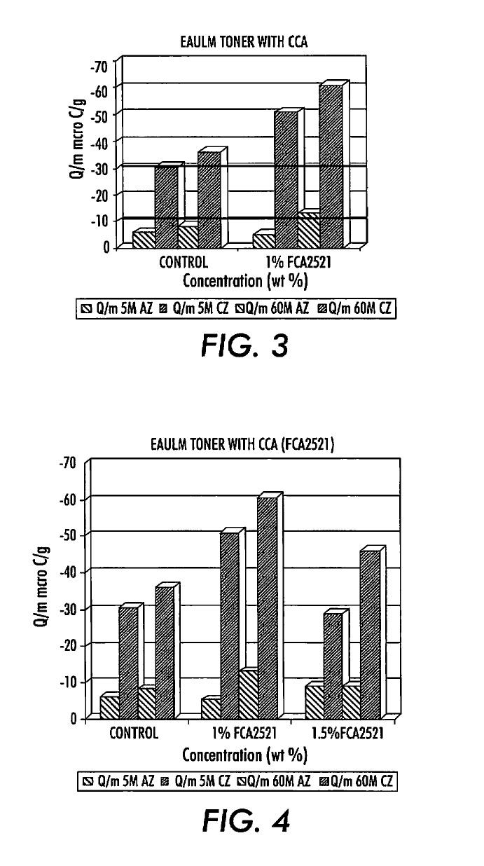

As demonstrated in FIG. 3, the toner of Example 4 possessing the charge control agent of Formula IV, at a level of 1%, decreased the charge in both the A and C zones when compared with the toner without the charge control agent. FIG. 4 is a graph of both the 1% the 1.5% concentration of the charge control agent of Formula IV in the toner shell (the toner of Examples 4 and 8) compared to the toner without the charge control agent. Incorporation of the charge control agent of Formula IV improved charging in the A and C zones.

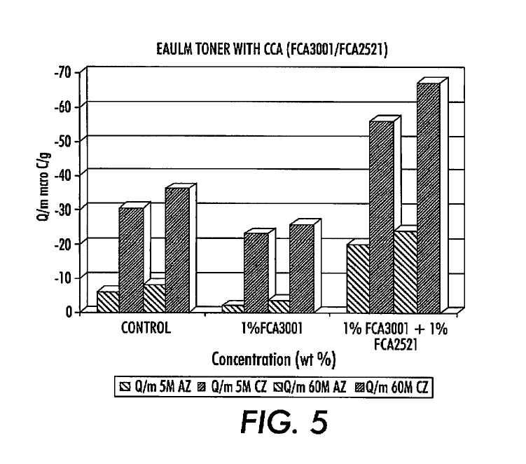

FIG. 5 represents the charge benefit provided by the 1% charge control agent of Formula III to the toner of Example 2 and the charge benefit provided to the toner of Example 10 by the combination of 1% charge control agent of Formula III and 1% charge control agent of Formula IV.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An emulsion aggregation toner comprising:
a core comprising at least one amorphous resin, at least one crystalline resin, and one or more optional ingredients selected from the group consisting of colorants, waxes, styrene/acrylate gels, and combinations thereof; and
a shell comprising at least one amorphous shell resin co-emulsified with one or more polymeric charge control agents.

2. The toner of claim 1, wherein the polymeric charge control agent is an magnesium-aluminum hydroxide carbonate inorganic polymer, having an Mg to Al ratio of from 1.9:1 to 3.1:1, containing from 1% to 45% by weight of a combination of sebacic acid with a C12-C44 fatty acid or a partly fluorinated or perflourinated sulfosuccinic acid (C6-C22)alkyl monoester, wherein the ratio between sebacic acid and the fatty acid or the sulfosuccinic monoester is from 1:50 to 5:1.

3. The toner of claim 2, wherein the magnesium-aluminum hydroxide carbonate is selected from the group consisting of
Mg₄Al₂(OH)₁₂(CO₃)_{b}Zₐ.nH₂O, and
Mg₆Al₂(OH)₁₆(CO₃)_{b} Zₐ.nH₂O
where b is from 0 to 1, n is from zero to 10, Z is a combination of anions of sebacic acid with one or more C12-C44 fatty acids or a partly fluorinated or perflourinated sulfosuccinic acid (C6-C22)alkyl monoester, and the number a is such that Z accounts for from 1% to 45% by weight, based on the total weight of the compound, and where the ratio between sebacic acid and the fatty acid or the sulfosuccinic monoester is from 1:50 to 5:1.

4. The toner of claim 1, wherein the polymeric charge control agent is a sulfonated low molecular weight styrene/acrylic copolymer with the following structure: 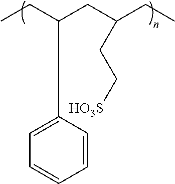
wherein n is from about 1 to about 1000.

5. The toner of claim 1, wherein the charge control agent is an organic polymer having a formula: 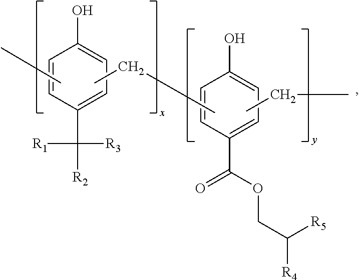
wherein x is 0.4 to 0.8, y is 0.2 to 0.6, R₁,R₂, and R₃ are each independently hydrogen or an alkyl, and R₄ and R₅ are each independently an alkyl.

6. The toner of claim 1, wherein the charge control agent is present in an amount from about 0.1 percent by weight to about 10 percent by weight of the shell, or from 0.5 percent to 5 percent.

7. The toner of claim 1, wherein the at least one amorphous resin comprises 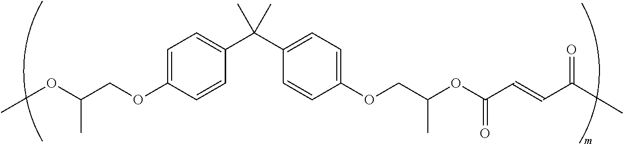
wherein m may be from about 5 to about 1000.

8. The toner of claim 1, wherein the at least one crystalline resin comprises 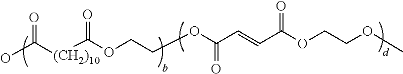
wherein b is from about 5 to about 2000 and d is from about 5 to about 2000.

9. An emulsion aggregation toner comprising:
a core comprising at least one amorphous resin, at least one crystalline resin and one or more optional ingredients selected from the group consisting of colorants, waxes, styrene/acrylate gels, and combinations thereof; and
a shell comprising at least one amorphous resin co-emulsified with a charge control agent selected from the group consisting of 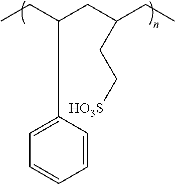
wherein n is from about 1 to about 1000, 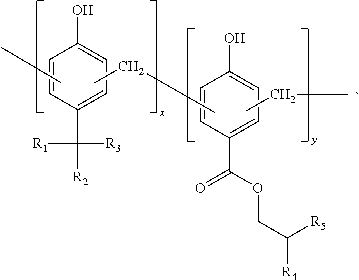
wherein x is 0.4 to 0.8, y is 0.2 to 0.6, R₁,R₂, and R₃ are each independently hydrogen or an alkyl, and R₄ and R₅ are each independently an alkyl, and
a magnesium-aluminum hydroxide carbonate selected from the group consisting of
Mg₄Al₂(OH)₁₂(CO₃)_{b}Zₐ.nH₂O, and
Mg₆Al₂(OH)₁₆(CO₃)_{b}Zₐ.nH₂O
where b is from 0 to 1, n is from zero to 10, Z is a combination of anions of sebacic acid with one or more C12-C44 fatty acids or a partly fluorinated or perflourinated sulfosuccinic acid (C6-C22)alkyl monoester, and the number a is such that Z accounts for from 1% to 45% by weight, based on the total weight of the compound, and where the ratio between sebacic acid and the fatty acid or the sulfosuccinic monoester is from 1:50 to 5:1, and
combinations thereof.

10. The toner of claim 9, wherein the polymeric charge control agent present in an amount from about 0.1 percent by weight to about 10 percent by weight of the shell.

11. The toner of claim 9, wherein the charge control agents is a combination of charge control agent having the formula 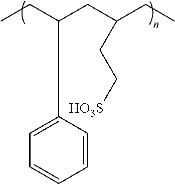
wherein n is from about 1 to about 1000, and a charge control agent having the formula 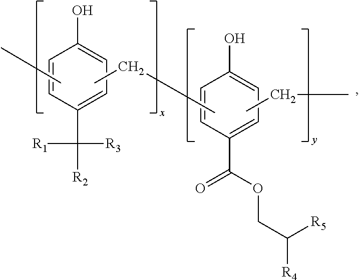
wherein x is 0.4 to 0.8, y is 0.2 to 0.6, R₁,R₂, and R₃ are each independently hydrogen or an alkyl, and R₄ and R₅ are each independently an alkyl.

12. The toner of claim 11, wherein the charge control agents are at a weight ratio of from about 10:90 to about 90:10.

13. The toner of claim 9, wherein the at least one amorphous resin comprises 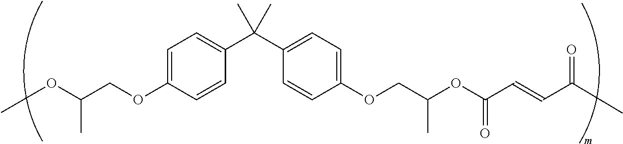
wherein m may be from about 5 to about 1000.

14. The toner of claim 9, wherein the at least one crystalline resin comprises 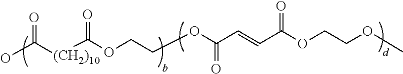
wherein b is from about 5 to about 2000 and d is from about 5 to about 2000.

15. A process comprising:
contacting at least one amorphous resin with at least one crystalline resin and at least one styrene/acrylate gel in a mixture;
aggregating the mixture to form core particles;
contacting the core particles with an emulsion comprising an amorphous resin in combination with a charge control agent comprising at least one polymeric charge control agent to form a shell over the particles; and
recovering the toner particles.

16. The process of claim 15, wherein the charge control agent comprises 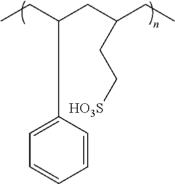
wherein n is from about 1 to about 1000.

17. The process of claim 15, wherein the charge control agent comprises 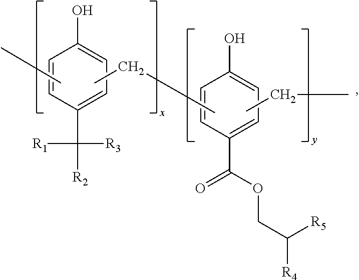
wherein x is 0.4 to 0.8, y is 0.2 to 0.6, R₁,R₂, and R₃ are each independently hydrogen or an alkyl, and R₄ and R₅ are each independently an alkyl.

18. The process of claim 15, wherein the charge control agent comprises a magnesium-aluminum hydroxide carbonate selected from the group consisting of
Mg₄Al₂(OH)₁₂(CO₃)_{b}Zₐ.nH₂O, and
Mg₆Al₂(OH)₁₆(CO₃)_{b}Zₐ.nH₂O
where b is from 0 to 1, n is from zero to 10, Z is a combination of anions of sebacic acid with one or more C12-C44 fatty acids or a partly fluorinated or perflourinated sulfosuccinic acid (C6-C22)alkyl monoester, and the number a is such that Z accounts for from 1% to 45% by weight, based on the total weight of the compound, and where the ratio between sebacic acid and the fatty acid or the sulfosuccinic monoester is from 1:50 to 5:1.

19. The process of claim 15, wherein the charge control agent is a combination of a charge control agent having the formula 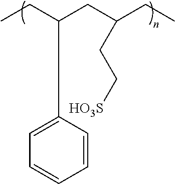
wherein n is from about 1 to about 1000, and a charge control agent having the formula 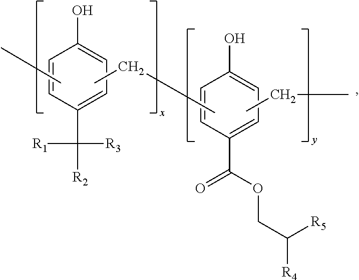
wherein x is 0.4 to 0.8, y is 0.2 to 0.6, R₁,R₂, and R₃ are each independently hydrogen or an alkyl, and R₄ and R₅ are each independently an alkyl.

20. The process of claim 19, wherein the charge control agents are at a weight ratio of from about 10:90 to about 90:10.
